(19) United States
(12) Patent Application Publication
(10) Pub. No.: US 2026/0341762 A1
(43) Pub. Date: Oct. 29, 2026

(54) APPARATUS FOR CONTROLLING CELL VOLTAGE OF FUEL CELL STACK AND METHOD THEREOF

(71) Applicants: Hyundai Motor Company, Seoul (KR); Kia Corporation, Seoul (KR)

(72) Inventors: Dong Kwan LEE, Hwaseong-si (KR); Hyoung Jun PARK, Hwaseong-Si (KR)

(73) Assignees: Hyundai Motor Company, Seoul (KR); Kia Corporation, Seoul (KR)

(21) Appl. No.: 19/326,459

(22) Filed: Sep. 11, 2025

(30) Foreign Application Priority Data
Apr. 28, 2025 (KR) 10-2025-0055682

(51) Int. Cl. H01M 8/04858; B60L 58/40; H01M 8/04537; H01M 16/00; B60L 50/75

(52) U.S. Cl. CPC H01M 8/0488; B60L 58/40; H01M 8/04626; H01M 16/006; B60L 50/75; B60L 2240/547; H01M 2220/20; H01M 2250/20; H01M 2250/402

(57) ABSTRACT

In an apparatus for controlling a cell voltage of a fuel cell stack and a method thereof, the apparatus includes a battery provided in a fuel cell vehicle, a fuel cell stack provided in the fuel cell vehicle, and a processor that obtains a state of charge (SOC) value and a maximum output value of the battery, obtains an output voltage of the fuel cell stack, determines a lower limit voltage of a cell voltage within the fuel cell stack based on the SOC and the maximum output value of the battery and the output voltage of the fuel cell stack, and limits the cell voltage to the lower limit voltage.

### CROSS-REFERENCE TO RELATED APPLICATION

The present application claims the benefit of priority to Korean Patent Application No. 10-2025-0055682, filed on Apr.28, 2025, the entire contents of which are incorporated herein by reference.

### FIELD OF THE PRESENT DISCLOSURE

The present disclosure relates to a technology for controlling the lower limit voltage of a cell voltage to maximize the durability of a fuel cell stack disposed in a fuel cell vehicle.

### BACKGROUND

In general, a fuel cell is a type of power generator that converts the chemical energy of fuel into electrical energy through an electrochemical reaction within a stack rather than converting it into heat through combustion. The fuel cell may be used not only to supply power for industrial, household, and vehicle driving purposes, but also to supply power to small electric/electronic products, especially portable devices.

Currently, a polymer electrolyte membrane fuel cell (PEMFC: Proton Exchange Membrane Fuel Cell), which has the highest power density among fuel cells, has been studied the most widely as a power source for driving a vehicle, and has a fast start-up time and fast power conversion response time due to its low operating temperature.

Such a polymer electrolyte membrane fuel cell includes a membrane electrode assembly (MEA) having catalyst electrode layers which an electrochemical reaction occurs therein and is attached on both sides of the membrane about a solid polymer electrolyte membrane through which hydrogen ions move, a gas diffusion layer (GDL) for evenly distributing reaction gases and transmitting the generated electrical energy, a gasket and a fastening device for maintaining the tightness and proper fastening pressure of reaction gases and cooling water, and a bipolar plate for moving reaction the reaction gases and cooling water.

When assembling a fuel cell stack using such a unit cell, the combination of the membrane electrode assembly and the gas diffusion layer, which are the main components, is located at the innermost part of the cell. The membrane electrode assembly has a catalyst electrode layer, that is, an anode and a cathode, on which a catalyst is applied on both sides of a polymer electrolyte membrane such that hydrogen reacts with oxygen, and a gas diffusion layer, a gasket, and the like are stacked on the external part where the anode and cathode are located. In the instant case, a bipolar plate is positioned outside the gas diffusion layer, in which a flow field is formed through which reaction gas (hydrogen as fuel and oxygen or air as oxidizer) is supplied and cooling water passes.

Using such a configuration as a unit cell, a plurality of unit cells are stacked, and then an end plate for supporting a current collector, an insulating plate, and the stacked cells is combined on the outermost side. By repeatedly stacking and connecting the unit cells between end plates, a fuel cell stack is formed.

To obtain the required potential in an actual vehicle, unit cells are stacked as much as the required potential and stacked unit cells are called a stack. The potential generated from one unit cell is approximately 1.3 V, and plural cells are stacked in series to produce the power required to drive a vehicle.

When hydrogen is supplied to the fuel electrode of such a stack and oxygen is supplied to the air electrode, hydrogen ions are separated through a catalytic reaction at the fuel electrode. The separated hydrogen ions are transferred to the oxidizing electrode, which is the air electrode, through an electrolyte membrane, and at the oxidizing electrode, the hydrogen ions separated from the fuel electrode, along with electrons and oxygen, cause an electrochemical reaction so that electrical energy is obtained. Specifically, electrochemical oxidation of hydrogen occurs at the fuel electrode, and electrochemical reduction of oxygen occurs at the air electrode. Electricity and heat are generated by the movement of electrons generated during the present process, and water vapor or water is generated by the chemical reaction of combining hydrogen and oxygen.

Meanwhile, a fuel cell vehicle differentially distributes the output between the fuel cell stack and the battery by considering the status of the fuel cell stack and the status of the battery, and the like, to generate the output that matches the intention (i.e., the driver-requested output) of a driver. In the instant case, the output distribution ratio, which serves as a reference for distributing the output between the fuel cell stack and the battery, is determined in advance.

Because such an output distribution ratio is a value determined at the generation of life (BoL) point when the condition of the fuel cell stack is optimal, the output of the fuel cell stack may vary depending on the condition of the fuel cell stack. For example, a fuel cell stack may produce 60 kW of power when the cell voltage is a first voltage, and may produce 60 kW of power when the cell voltage is a second voltage.

Ultimately, the conventional technology for controlling the cell voltage of a fuel cell stack may generate the driver's requested output even while maintaining the cell voltage (for example, 0.7 V to 0.8 V) that can secure the durability of the fuel cell stack due to sufficient available output of the battery, but can weaken the durability of the fuel cell stack because it lowers the cell voltage to 0.5 V to 0.7 V, which has a negative effect on the durability of the fuel cell stack. That is, because a conventional technology controls the cell voltage based on a preset output distribution ratio without considering the durability of a fuel cell stack, it may weaken the durability of the fuel cell stack. For reference, the fuel cell stack has an operating region with a low degradation rate depending on the number of cells. For example, the operating region is a region where the cell voltage is 0.7 V to 0.8 V.

The matters described in this Background section are intended to promote an understanding of the background of the present disclosure and may include matters that are not already known to those of ordinary skill in the art.

### BRIEF SUMMARY

The present disclosure has been made to solve the above-mentioned problems occurring in the related art while advantages achieved by the related art are maintained intact.

One aspect of the present disclosure provides an apparatus for controlling a cell voltage of a fuel cell stack and a method thereof configured for satisfying the output required by a driver while maximizing the durability of the fuel cell stack to maintain the driving performance of a fuel cell vehicle by obtaining a state of charge (SOC) value and a maximum output value of a battery disposed in a fuel cell vehicle, obtaining an output voltage of a fuel cell stack disposed in the fuel cell vehicle, determining a lower limit voltage of a cell voltage within the fuel cell stack based on the SOC value and the maximum output value of the battery and the output voltage of the fuel cell stack, and controlling the voltage of the fuel cell stack based on the lower limit voltage of the fuel cell stack corresponding to the lower limit voltage of the cell voltage.

Another aspect of the present disclosure provides an apparatus for controlling a cell voltage of a fuel cell stack and a method thereof configured for satisfying the output required by a driver while maximizing the durability of the fuel cell stack to maintain the driving performance of a fuel cell vehicle by obtaining a state of charge (SOC) value and a maximum output value of a battery disposed in a fuel cell vehicle, obtaining an output voltage of a fuel cell stack disposed in the fuel cell vehicle, determining a lower limit voltage of a cell voltage within the fuel cell stack as a first lower limit voltage based on that the SOC value of the battery exceeds a first reference SOC value, based on that the maximum output value of the battery exceeds a first threshold value, or based on that the output voltage of the fuel cell stack exceeds a threshold voltage, determining the lower limit voltage of the fuel cell stack corresponding to the first lower limit voltage of the cell voltage, and controlling the voltage of the fuel cell stack not to fall below the lower limit voltage.

Yet another aspect of the present disclosure provides an apparatus for controlling a cell voltage of a fuel cell stack and a method thereof configured for satisfying the output required by a driver while maximizing the durability of the fuel cell stack to maintain the driving performance of a fuel cell vehicle by obtaining a state of charge (SOC) value and a maximum output value of a battery disposed in a fuel cell vehicle, obtaining a target output value and an actual output value of the fuel cell stack disposed in the fuel cell vehicle, determining a lower limit voltage of a cell voltage within the fuel cell stack based on the SOC value and the maximum output value of the battery and the target output value and the actual output voltage of the fuel cell stack, and controlling the voltage of the fuel cell stack based on the lower limit voltage of the fuel cell stack corresponding to the lower limit voltage of the cell voltage.

Yet another aspect of the present disclosure provides an apparatus for controlling a cell voltage of a fuel cell stack and a method thereof configured for satisfying the output required by a driver while maximizing the durability of the fuel cell stack to maintain the driving performance of a fuel cell vehicle by obtaining a state of charge (SOC) value and a maximum output value of a battery disposed in a fuel cell vehicle, obtaining a target output value and an actual output value of the fuel cell stack disposed in the fuel cell vehicle, determining, as a second lower limit voltage, a lower limit voltage of a cell voltage within the fuel cell stack based on that the SOC value of the battery does not exceed a second reference SOC value, based on that the maximum output value of the battery does not exceed a second threshold value, or based on that the value obtained by subtracting the actual output value from the target output value of the fuel cell stack exceeds a threshold output, determining the lower limit voltage of the fuel cell stack corresponding to the second lower limit voltage of the cell voltage, and controlling the voltage of the fuel cell stack not to fall below the lower limit voltage.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to one aspect of the present disclosure, an apparatus for controlling a cell voltage of a fuel cell stack includes a battery disposed in a fuel cell vehicle, a fuel cell stack disposed in the fuel cell vehicle, and a processor that obtains a state of charge (SOC) value and a maximum output value of the battery, obtains an output voltage of the fuel cell stack, determines a lower limit voltage of a cell voltage within the fuel cell stack based on the SOC value and the maximum output value of the battery and the output voltage of the fuel cell stack, and limits the cell voltage to the lower limit voltage.

According to one aspect of the present disclosure, the processor is configured to determine the lower limit voltage of the cell voltage based on that the SOC value of the battery exceeds a first reference SOC value.

According to one aspect of the present disclosure, the processor is configured to determine the lower limit voltage of the cell voltage based on that the maximum output value of the battery exceeds a first threshold value.

According to one aspect of the present disclosure, the processor is configured to determine the lower limit voltage of the cell voltage based on that the output voltage of the fuel cell stack exceeds a threshold voltage.

According to one aspect of the present disclosure, the processor is configured to determine a lower limit voltage of the fuel cell stack corresponding to the lower limit voltage of the cell voltage, and limit a target output of the fuel cell stack based on that the output voltage of the fuel cell stack reaches the lower limit voltage of the fuel cell stack.

According to one aspect of the present disclosure, the processor may obtain a bidirectional high voltage converter (BHDC) voltage command as the output voltage of the fuel cell stack.

According to one aspect of the present disclosure, the processor may release the limitation of the cell voltage based on that the SOC value of the battery does not exceed a second reference SOC value.

According to one aspect of the present disclosure, the processor may release the limitation of the cell voltage based on that the maximum output value of the battery does not exceed a second threshold value.

According to one aspect of the present disclosure, the processor may release the limitation of the cell voltage based on that a value obtained by subtracting an actual output value from a target output value of the fuel cell stack exceeds a value obtained by subtracting an output distribution value and a margin of the battery from the maximum output value of the battery.

According to one aspect of the present disclosure, the processor is configured to determine the lower limit voltage of the cell voltage within the fuel cell stack based on the SOC value and the maximum output value of the battery and the output voltage of the fuel cell stack, and re-limit the cell voltage to the lower limit voltage based on that the limitation of the cell voltage is released.

According to various aspects of the present disclosure, a method for controlling a cell voltage of a fuel cell stack includes obtaining, by a processor, a state of charge (SOC) value and a maximum output value of a battery disposed in a fuel cell vehicle, obtaining, by the processor, an output voltage of a fuel cell stack disposed in the fuel cell vehicle, determining, by the processor, a lower limit voltage of a cell voltage within the fuel cell stack based on the SOC value and the maximum output value of the battery and the output voltage of the fuel cell stack, and limiting, by the processor, the cell voltage to the lower limit voltage.

According to one aspect of the present disclosure, the determining of the lower limit voltage may include determining the lower limit voltage of the cell voltage based on that the SOC value of the battery exceeds a first reference SOC value.

According to one aspect of the present disclosure, the determining of the lower limit voltage may include determining the lower limit voltage of the cell voltage based on that the maximum output value of the battery exceeds a first threshold value.

According to one aspect of the present disclosure, the determining of the lower limit voltage may include determining the lower limit voltage of the cell voltage based on that the output voltage of the fuel cell stack exceeds a threshold voltage.

According to one aspect of the present disclosure, the method may further include determining, by the processor, a lower limit voltage of the fuel cell stack corresponding to the lower limit voltage of the cell voltage, and limiting, by the processor, a target output of the fuel cell stack based on that the output voltage of the fuel cell stack reaches the lower limit voltage of the fuel cell stack.

According to one aspect of the present disclosure, the obtaining of the output voltage of the fuel cell stack may include obtaining a bidirectional high voltage converter (BHDC) voltage command as the output voltage of the fuel cell stack.

According to one aspect of the present disclosure, the method may further include obtaining, by the processor, a target output value and an actual output value of the fuel cell stack, releasing, by the processor, the limitation of the cell voltage based on the SOC value and the maximum output value of the battery, and the target output value and the actual output value of the fuel cell stack, determining the lower limit voltage of the cell voltage within the fuel cell stack based on the SOC value and the maximum output value of the battery and the output voltage of the fuel cell stack, and re-limiting the cell voltage to the lower limit voltage.

According to one aspect of the present disclosure, the releasing of the limitation of the cell voltage may include releasing the limitation of the cell voltage based on that the SOC value of the battery does not exceed a second reference SOC value.

According to one aspect of the present disclosure, the releasing of the limitation of the cell voltage may include releasing the limitation of the cell voltage based on that the maximum output value of the battery does not exceed a second threshold value.

According to one aspect of the present disclosure, the releasing of the limitation of the cell voltage may include releasing the limitation of the cell voltage when a value obtained by subtracting an actual output value from a target output value of the fuel cell stack exceeds a value obtained by subtracting an output distribution value and a margin of the battery from the maximum output value of the battery.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an apparatus for controlling a cell voltage of a fuel cell stack according to an exemplary embodiment of the present disclosure;

FIG. 2 is a diagram illustrating a process in which a controller disposed in an apparatus for controlling a cell voltage of a fuel cell stack according to an exemplary embodiment of the present disclosure determines the final target output of the fuel cell stack;

FIG. 3 is a diagram illustrating a result of preventing air supercharging by determining the final target output of a fuel cell stack by a controller disposed in an apparatus for controlling a cell voltage of a fuel cell stack according to an exemplary embodiment of the present disclosure;

FIG. 4 is a diagram illustrating a cell voltage limiting logic of a controller disposed in an apparatus for controlling a cell voltage of a fuel cell stack according to an exemplary embodiment of the present disclosure;

FIG. 5 is a diagram illustrating a cell voltage limitation release logic of a controller disposed in an apparatus for controlling a cell voltage of a fuel cell stack according to an exemplary embodiment of the present disclosure;

FIG. 6 is a diagram illustrating a first example of the performance of an apparatus for controlling a cell voltage of a fuel cell stack according to an exemplary embodiment of the present disclosure;

FIG. 7 is a diagram illustrating a second example of the performance of an apparatus for controlling a cell voltage of a fuel cell stack according to an exemplary embodiment of the present disclosure;

FIG. 8 is a flowchart illustrating a method for controlling a cell voltage of a fuel cell stack according to an exemplary embodiment of the present disclosure; and

FIG. 9 is a block diagram illustrating a computing system for executing a method for controlling a cell voltage of a fuel cell stack according to various exemplary embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is specified by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

Terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, include the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure.

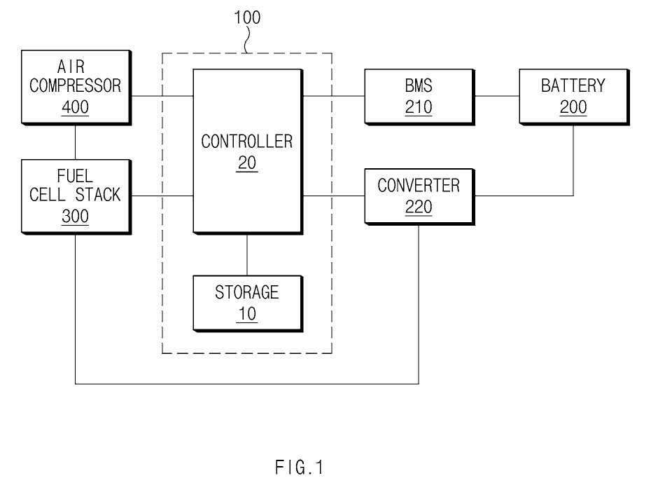

FIG. 1 is a block diagram illustrating an apparatus for controlling a cell voltage of a fuel cell stack according to an exemplary embodiment of the present disclosure.

As illustrated in FIG. 1, an apparatus 100 for controlling a cell voltage of a fuel cell stack according to an exemplary embodiment of the present disclosure may include storage 10 and a controller 20. In the instant case, depending on scheme of implementing the apparatus 100 for controlling a cell voltage of a fuel cell stack according to an exemplary embodiment of the present disclosure, components may be combined with each other to be implemented as one, or some components may be omitted.

Regarding each component, first, the storage 10 may store various logic, algorithms and programs required in a process of obtaining the state of charge (SOC) value and maximum output value of a battery 200 disposed in a fuel cell vehicle, obtaining an output voltage of a fuel cell stack 300 disposed in the fuel cell vehicle, determining a lower limit voltage of the cell voltage within the fuel cell stack 300 based on the SOC value and the maximum output value of the battery 200 and the output voltage of the fuel cell stack 300, and controlling the voltage of the fuel cell stack 300 based on the lower limit voltage of the fuel cell stack 300 corresponding to the lower limit voltage of the cell voltage.

The storage 10 may store various logic, algorithms and programs required in a process of obtaining the SOC value and maximum output value of the battery 200 disposed in the fuel cell vehicle, obtaining an output voltage of the fuel cell stack 300 disposed in the fuel cell vehicle, determining a lower limit voltage of the cell voltage within the fuel cell stack 300 as a first lower limit voltage when the SOC value of the battery 200 exceeds a first reference SOC value, when the maximum output value of the battery 200 exceeds a first threshold value, or when the output voltage of the fuel cell stack 300 exceeds a threshold voltage, determining the lower limit voltage of the fuel cell stack 300 corresponding to the first lower limit voltage of the cell voltage, and controlling the voltage of the fuel cell stack 300 not to fall below the lower limit voltage.

The storage 10 may store various logic, algorithms and programs required in a process of obtaining the SOC value and maximum output value of the battery 200 disposed in the fuel cell vehicle, obtaining a target output value and an actual output value of the fuel cell stack 300 disposed in the fuel cell vehicle, determining a lower limit voltage of the cell voltage within the fuel cell stack 300 based on the SOC value and the maximum output value of the battery 200 and the target output value and the actual output value of the fuel cell stack 300, and controlling the voltage of the fuel cell stack 300 based on the lower limit voltage of the fuel cell stack 300 corresponding to the lower limit voltage of the cell voltage.

The storage 10 may store various logic, algorithms and programs required in a process of obtaining the SOC value and maximum output value of the battery 200 disposed in the fuel cell vehicle, obtaining a target output value and an actual output value of the fuel cell stack 300 disposed in the fuel cell vehicle, determining, as a second lower limit voltage, a lower limit voltage of the cell voltage within the fuel cell stack when the SOC value of the battery 200 does not exceed a second reference SOC value, when the maximum output value of the battery 200 does not exceed a second threshold value, or when the value obtained by subtracting the actual output value from the target output value of the fuel cell stack 300 exceeds a threshold output, determining the lower limit voltage of the fuel cell stack 300 corresponding to the second lower limit voltage of the cell voltage, and controlling the voltage of the fuel cell stack 300 not to fall below the lower limit voltage.

The controller 20 may be electrically connected to each component and may perform overall control such that each component performs its function. The controller 20 may be implemented in a form of hardware or software, or may be implemented in a combination of hardware and software. The controller 20 may be implemented as a microprocessor, but is not limited thereto.

The controller 20 may obtain the SOC value and maximum output value of the battery 200 disposed in the fuel cell vehicle, In the instant case, the controller 20 may obtain the SOC value and maximum output value of the battery 200 in conjunction with a BMS 210.

For reference, the BMS 210, which is a module located in a pack of the battery 200 to manage the battery 200, may manage the SOH of the battery 200, the SOC value of the battery 200, the pack voltage of the battery 200, the module voltage of the battery 200, the cell voltage of the battery 200, the current of the battery 200, the temperature of the battery 200, the coolant temperature, the cell balancing time and number of times, the number of slow charges and an amount of energy, the number of rapid charges and an amount of energy, the accumulated charging power and an amount of energy, the accumulated discharge power and an amount of energy, and the DTC occurrence history information. In the instant case, the DTC occurrence history information may include the DTC caused by overcharging of the battery 200 and the number of occurrences of DTCs related to the overcharging, the DTC caused by over-discharge of the battery 200, the number of occurrences of DTCs related to over-discharge, and the like.

The controller 20 may obtain the output voltage of the fuel cell stack 300 disposed in the fuel cell vehicle. In the instant case, the output voltage may include a bidirectional high voltage converter (BHDC 220) voltage command that commands the voltage to be output by the fuel cell stack 300.

The controller 20 may be configured to determine the lower limit voltage of the cell voltage within the fuel cell stack 300 based on the SOC value and the maximum output value of the battery 200 and the output voltage of the fuel cell stack 300, and control the voltage of the fuel cell stack 300 based on the lower limit voltage of the fuel cell stack 300 corresponding to the lower limit voltage of the cell voltage.

For example, when the SOC value of the battery 200 exceeds a first reference SOC value (e.g., 60%), when the maximum output value of the battery 200 exceeds a first threshold value (e.g., 50 kw), or when the output voltage of the fuel cell stack 300 exceeds a threshold voltage, the controller 20 may be configured to determine the lower limit voltage of the cell voltage within the fuel cell stack 300 as the first lower limit voltage (e.g., 07 V to 0.8 V). In the instant case, the first lower limit voltage may be determined based on the point at which the amount of platinum catalyst released rapidly increases with changes in cell voltage. Therefore, the first lower limit voltage may vary depending on the specifications of the fuel cell stack 300 and the specifications of the catalyst. Furthermore, the controller 20 may be configured to determine the lower limit voltage of the fuel cell stack 300 corresponding to the first lower limit voltage of the cell voltage, and control the voltage of the fuel cell stack 300 so that the voltage of the fuel cell stack 300 does not fall below the lower limit voltage. In the instant case, the threshold voltage may be, for example, a value obtained by adding a margin to the voltage of the fuel cell stack 300 corresponding to the first lower limit voltage of the cell voltage.

When the lower limit voltage of the cell voltage within the fuel cell stack 300 is limited to the first lower limit voltage, the output voltage of the fuel cell stack 300 may reach the lower limit voltage of the fuel cell stack 300 corresponding to the first lower limit voltage of the cell voltage. When the output voltage of the fuel cell stack 300 reaches the lower limit voltage of the fuel cell stack 300 corresponding to the first lower limit voltage of the cell voltage, the controller 20 may be configured to determine a smaller value among the final target output of the fuel cell stack 300 in a previous operation and the target output of the fuel cell stack 300 in a current operation as the final target output of the fuel cell stack 300 in the current operation.

Meanwhile, the controller 20 may obtain the target output value and actual output value of the fuel cell stack 300 disposed in the fuel cell vehicle.

The controller 20 may be configured to determine the lower limit voltage of the cell voltage within the fuel cell stack 300 based on the SOC value and the maximum output value of the battery 200 and the target output value and the actual output value of the fuel cell stack 300, and may be configured for controlling the voltage of the fuel cell stack 300 based on the lower limit voltage of the fuel cell stack 300 corresponding to the lower limit voltage of the cell voltage.

For example, when the SOC value of the battery 200 does not exceed the second reference SOC value (e.g., 50%), when the maximum output value of the battery 200 does not exceed the second threshold value (e.g., 30 kw), or when the value obtained by subtracting the actual output value from the target output value of the fuel cell stack 300 exceeds the threshold output, the controller 20 may be configured to determine the lower limit voltage of the cell voltage within the fuel cell stack 300 as the second lower limit voltage (e.g., 0.5V to 0.7 V). Furthermore, the controller 20 may be configured to determine the lower limit voltage of the fuel cell stack 300 corresponding to the second lower limit voltage of the cell voltage, and control the voltage of the fuel cell stack 300 not to fall below the lower limit voltage.

The controller 20 may determine, as the threshold output, the value obtained by subtracting the output distribution value and margin of the battery 200 from the maximum output value of the battery 200. Furthermore, the controller 20 may be configured to determine the minimum value among a final request output, a performance-based output limit value of the fuel cell stack 300, and a performance-based output limit value of the converter 220 as the target output value of the fuel cell stack 300. In the instant case, the final request output is the sum of the fuel cell request output and the fuel cell accessory power consumption output.

Meanwhile, in a state in which the lower limit voltage of the cell voltage within the fuel cell stack 300 is determined as the first lower limit voltage, when the SOC value of the battery 200 does not exceed the second reference SOC value (e.g., 50%), when the maximum output value of the battery 200 does not exceed the second threshold value (e.g., 30 kw), or when the value obtained by subtracting the actual output value from the target output value of the fuel cell stack 300 exceeds the threshold output, the controller 20 may release the voltage limitation of the fuel cell stack 300. That is, the controller 20 may lower the lower limit voltage of the cell voltage from the first lower limit voltage to the second lower limit voltage.

Thereafter, when the SOC value of the battery 200 exceeds the first reference SOC value (e.g., 60%), when the maximum output value of the battery 200 exceeds the first threshold value (e.g., 50 kw), or when the output voltage of the fuel cell stack 300 exceeds the threshold voltage, the controller 20 may set the voltage limitation of the fuel cell stack 300. That is, the controller 20 may restore the lower limit voltage of the cell voltage from the second lower limit voltage to the first lower limit voltage.

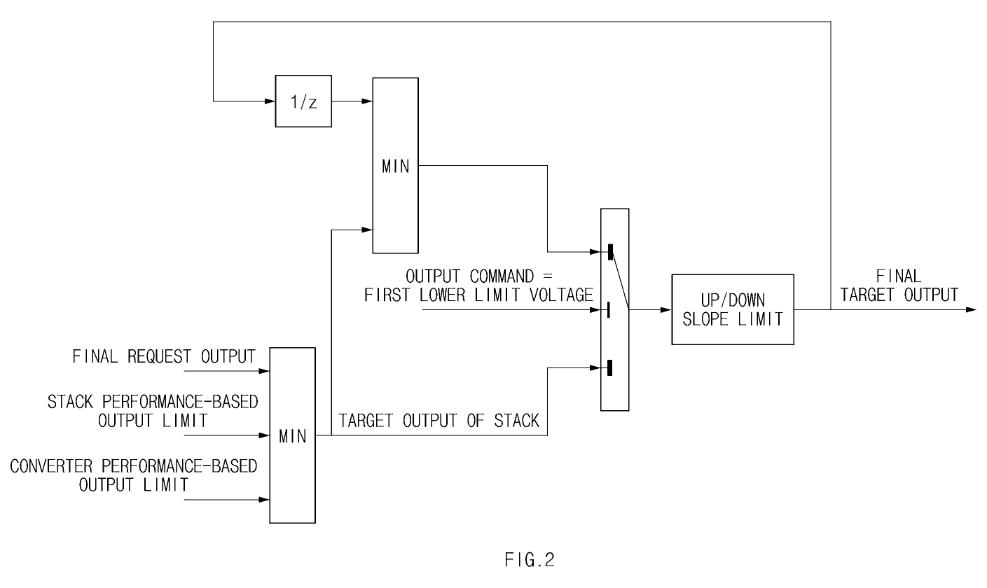

Hereinafter, the detailed operation of the controller 20 will be described with reference to FIGS. 2,3,4,5,6 and 7 .

FIG. 2 is a diagram illustrating a process in which a controller disposed in an apparatus for controlling a cell voltage of a fuel cell stack according to an exemplary embodiment of the present disclosure is configured to determine the final target output of the fuel cell stack.

As illustrated in FIG. 2, when the lower limit voltage of the cell voltage within the fuel cell stack 300 is limited to the first lower limit voltage, at a time point when the output voltage of the fuel cell stack 300 reaches the lower limit voltage of the fuel cell stack 300 corresponding to the first lower limit voltage of the cell voltage, the controller 20 may be configured to determine a smaller value among the final target output of the fuel cell stack 300 in a previous operation and the target output of the fuel cell stack 300 in a current operation as the final target output of the fuel cell stack 300 in the current operation.

In the instant case, the controller 20 may be configured to determine the minimum value among the final request output, the performance-based output limit value of the fuel cell stack 300, and the performance-based output limit value of the converter 220 as the target output value of the fuel cell stack 300. In the instant case, the final request output is the sum of the fuel cell request output and the fuel cell accessory power consumption output.

When the final target output of the fuel cell stack 300 is not limited, the air flow rate to the cathode of the fuel cell stack 300 increases to pursue the increased target output, but the output voltage of the fuel cell stack 300 may not decrease any further, so an air supercharging phenomenon occurs. The controller 20 may prevent the air supercharging phenomenon by limiting the final target output of the fuel cell stack 300.

Furthermore, when the lower limit voltage of the cell voltage within the fuel cell stack 300 is not limited to the first lower limit voltage, the controller 20 may be configured to determine the target output of the fuel cell stack 300 at the current operation as the final target output of the fuel cell stack 300 at the current operation.

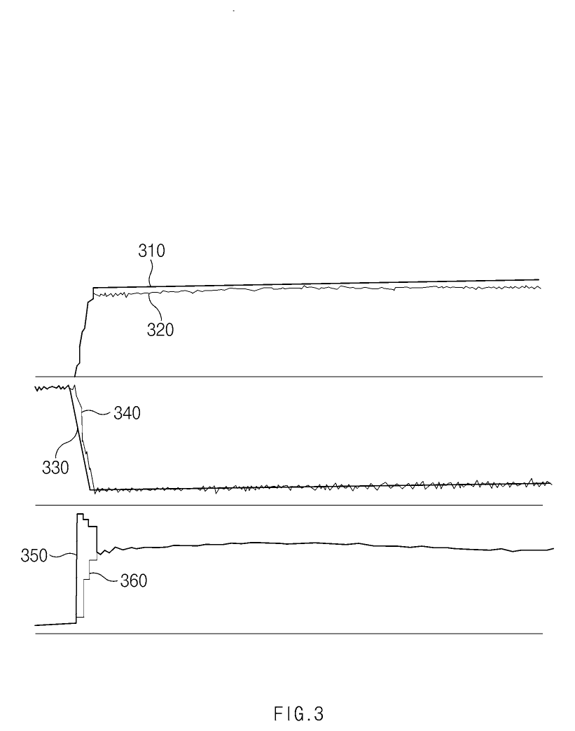

FIG. 3 is a diagram illustrating a result of preventing air supercharging by determining the final target output of a fuel cell stack by a controller disposed in an apparatus for controlling a cell voltage of a fuel cell stack according to an exemplary embodiment of the present disclosure.

In FIG. 3, reference numeral 310 represents the final target output of the fuel cell stack 300, and reference numeral 320 represents the actual output of the fuel cell stack 300. In the instant case, it may be understood that the actual output of the fuel cell stack 300 does not exceed the final target output. The controller 20 may be configured for controlling the fuel cell stack 300 so that the actual output of the fuel cell stack 300 does not exceed the final target output.

Reference numeral 330 represents the voltage command (e.g., 330 V) of the converter 220, and reference numeral 340 represents the actual voltage of the converter 220. In the instant case, it may be understood that the actual voltage of the converter 220 follows 330 V. The controller 20 may be configured for controlling the converter 220 so that the actual voltage of the converter 220 follows 330 V.

Reference numeral 350 represents a flow rate command (e.g., RPM) of an air compressor 400, and reference numeral 360 represents an actual flow rate of the air compressor 400. In the instant case, it may be understood that the actual flow rate of the air compressor 400 follows the flow rate command. The controller 20 may be configured for controlling the air compressor 400 so that the actual flow rate of the air compressor 400 follows the flow rate command.

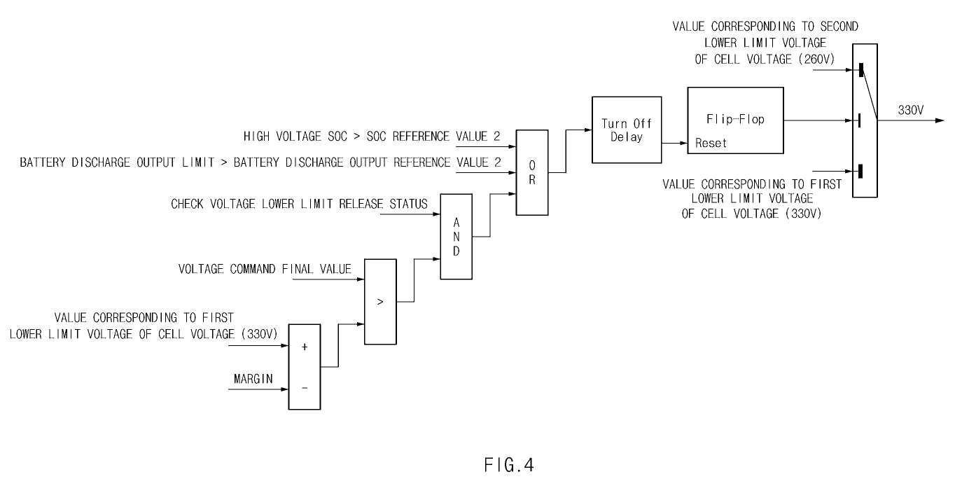

FIG. 4 is a diagram illustrating a cell voltage limiting logic of a controller disposed in an apparatus for controlling a cell voltage of a fuel cell stack according to an exemplary embodiment of the present disclosure.

First, when the output voltage (or voltage command) of the fuel cell stack 300 exceeds the sum of the voltage of the fuel cell stack 300 corresponding to the first lower limit voltage of the cell voltage and the margin, or the SOC value of the battery 200 exceeds the first reference SOC value (e.g., 60%), or the maximum output value of the battery 200 exceeds the first threshold value (e.g., 50 kW), the controller 20 is configured to determine the lower limit voltage(e.g., 330 V) of the fuel cell stack 300 corresponding to the first lower limit voltage of the cell voltage and is configured to control the voltage of the fuel cell stack 300 not to fall below 330 V.

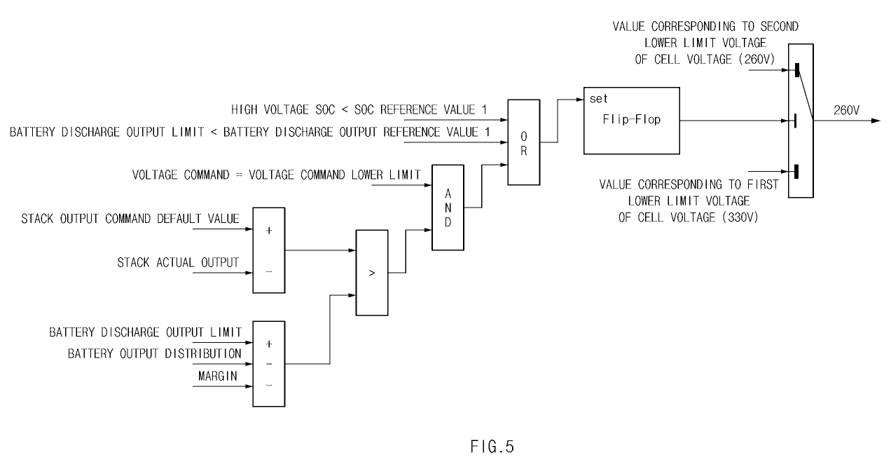

FIG. 5 is a diagram illustrating a cell voltage limitation release logic of a controller disposed in an apparatus for controlling a cell voltage of a fuel cell stack according to an exemplary embodiment of the present disclosure.

First, the controller 20 is configured to determine a first value by subtracting the actual output value from the target output value of the fuel cell stack 300, and is configured to determine a second value by subtracting the output distribution value and margin of the battery 200 from the maximum output value of the battery 200.

When the first value exceeds the second value, or the SOC value of the battery 200 does not exceed the second reference SOC value (e.g., 50%), or the maximum output value of the battery 200 does not exceed the second threshold value (e.g., 30 kW), the controller 20 is configured to determine the lower limit voltage (e.g., 260 V) of the fuel cell stack 300 corresponding to the second lower limit voltage of the cell voltage, and is configured to control the voltage of the fuel cell stack 300 not to fall below 260 V.

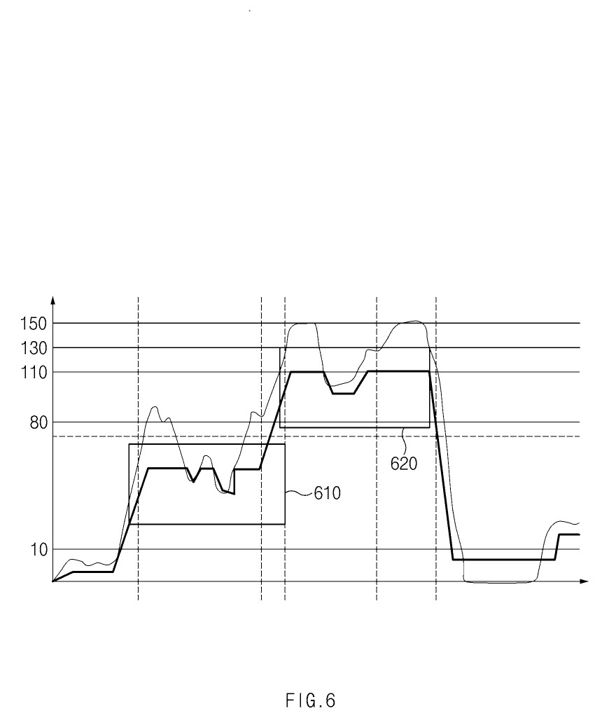

FIG. 6 is a diagram illustrating a first example of the performance of an apparatus for controlling a cell voltage of a fuel cell stack according to an exemplary embodiment of the present disclosure.

In FIG. 6, reference numeral 610 indicates a state in which the voltage limit of the cell voltage is set, and reference numeral 620 indicates a state in which the voltage limit of the cell voltage is released.

As illustrated in FIG. 6, it may be understood that in a state 610 where the voltage limit is set, the cell voltage does not fall below the first lower limit voltage, and in a state 620 where the voltage limit is set, the cell voltage falls below the first lower limit voltage.

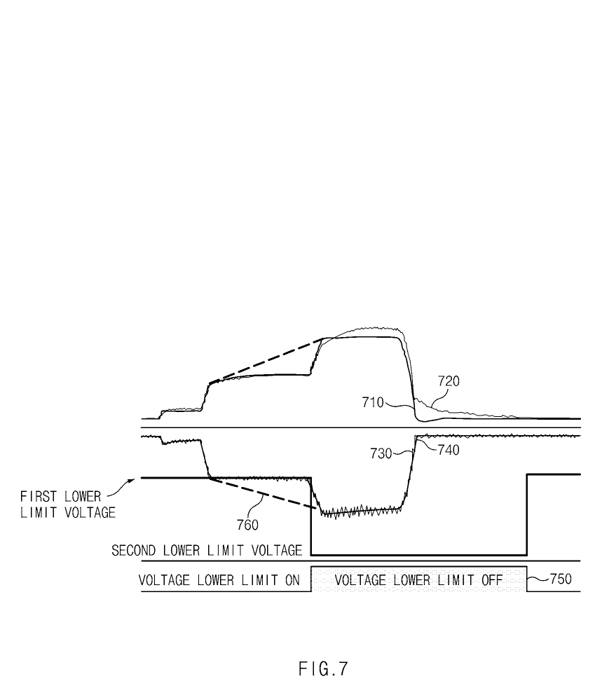

FIG. 7 is a diagram illustrating a second example of the performance of an apparatus for controlling a cell voltage of a fuel cell stack according to an exemplary embodiment of the present disclosure.

In FIG. 7, reference numeral 710 represents the final target output of the fuel cell stack 300, reference numeral 720 represents the actual output of the fuel cell stack 300, reference numeral 730 represents the voltage command of the BHDC, reference numeral 740 represents the actual voltage of the BHDC, reference numeral 750 represents whether the lower limit voltage of the cell voltage is limited, and reference numeral 760 represents the cell voltage when the present disclosure is not applied.

As illustrated in FIG. 7, when the lower limit of the cell voltage is ON, the durability of the fuel cell stack 300 may be secured by maintaining the cell voltage at the first lower limit voltage. When the lower limit of the cell voltage is OFF, the output assistance of the fuel cell stack 300 is required according to the driver's intention, and the driving performance of the vehicle may be maintained.

In the state where the lower limit of the cell voltage is OFF, when the SOC value of the battery 200 exceeds the first reference SOC value (e.g., 60%), when the maximum output value of the battery 200 exceeds the first threshold value (e.g., 50 kW), or when the output voltage of the fuel cell stack 300 exceeds the threshold voltage, the controller 20 may re-enter the state where the lower limit of the cell voltage is ON.

When the present disclosure is not applied at 760, although it is possible to maintain the cell voltage (e.g., 0.7 V to 0.8 V) that is configured to secure the durability of the fuel cell stack 300, the durability of the fuel cell stack 300 may not be secured because the cell voltage is lowered depending on the output distribution ratio.

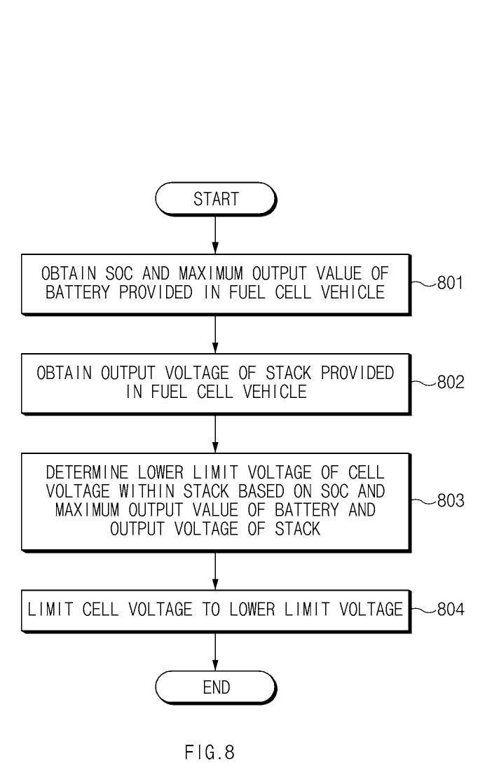

FIG. 8 is a flowchart illustrating a method for controlling a cell voltage of a fuel cell stack according to an exemplary embodiment of the present disclosure.

First, in 801, the controller 20 obtains the SOC value and maximum output value of the battery 200 disposed in the fuel cell vehicle.

Accordingly, in 802, the controller 20 obtains the output voltage of the fuel cell stack 300 disposed in the fuel cell vehicle.

Accordingly, in 803, the controller 20 is configured to determine the lower limit voltage of the cell voltage within the fuel cell stack 300 based on the SOC value and maximum output value of the battery 200 and the output voltage of the fuel cell stack 300.

Accordingly, in 804, the controller 20 limits the cell voltage to the lower limit voltage.

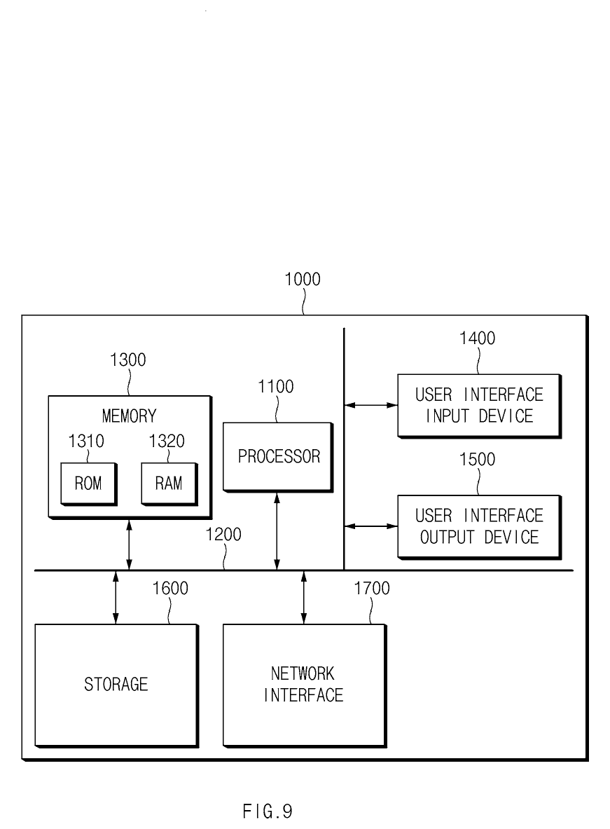

FIG. 9 is a block diagram illustrating a computing system for executing a method for controlling a cell voltage of a fuel cell stack according to various exemplary embodiments of the present disclosure.

Referring to FIG. 9, as described above, the method for controlling a cell voltage of a fuel cell stack according to an exemplary embodiment of the present disclosure may be implemented through a computing system 1000. The computing system 1000 may include at least one processor 1100, a memory 1300, a user interface input device 1400, a user interface output device 1500, storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to the exemplary embodiments of the present disclosure, it is possible to satisfy the output required by a driver while maximizing the durability of the fuel cell stack to maintain the driving performance of a fuel cell vehicle by obtaining a state of charge (SOC) value and a maximum output value of a battery disposed in a fuel cell vehicle, obtaining an output voltage of a fuel cell stack disposed in the fuel cell vehicle, determining a lower limit voltage of the cell voltage within the fuel cell stack based on the SOC value and the maximum output value of the battery and the output voltage of the fuel cell stack, and controlling the voltage of the fuel cell stack based on the lower limit voltage of the fuel cell stack corresponding to the lower limit voltage of the cell voltage.

Although exemplary embodiments of the present disclosure have been described for illustrative purposes, those skilled in the art will appreciate that various modifications, additions and substitutions are possible, without departing from the scope and spirit of the present disclosure. Therefore, the exemplary embodiments included in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for controlling a cell voltage of a fuel cell stack, the apparatus comprising:
a battery disposed in a fuel cell vehicle;
the fuel cell stack disposed in the fuel cell vehicle;
a processor; and
a non-transitory storage medium including program instructions executed by the processor,
wherein the processor:
obtains a state of charge (SOC) value and a maximum output value of the battery,
obtains an output voltage of the fuel cell stack,
determines a lower limit voltage of a cell voltage within the fuel cell stack based on the SOC value and the maximum output value of the battery and the output voltage of the fuel cell stack, and
limits the cell voltage to the lower limit voltage.

2. The apparatus of claim 1, wherein the processor determines the lower limit voltage of the cell voltage based on that the SOC value of the battery exceeds a first reference SOC value.

3. The apparatus of claim 1, wherein the processor determines the lower limit voltage of the cell voltage based on that the maximum output value of the battery exceeds a first threshold value.

4. The apparatus of claim 1, wherein the processor determines the lower limit voltage of the cell voltage based on that the output voltage of the fuel cell stack exceeds a threshold voltage.

5. The apparatus of claim 1,
wherein the processor determines a lower limit voltage of the fuel cell stack corresponding to the lower limit voltage of the cell voltage, and
wherein the processor limits a target output of the fuel cell stack based on that the output voltage of the fuel cell stack reaches the lower limit voltage of the fuel cell stack.

6. The apparatus of claim 1, wherein the processor obtains a bidirectional high voltage converter (BHDC) voltage command as the output voltage of the fuel cell stack.

7. The apparatus of claim 1, wherein the processor releases the limitation of the cell voltage based on that the SOC value of the battery does not exceed a second reference SOC value.

8. The apparatus of claim 1, wherein the processor releases the limitation of the cell voltage based on that the maximum output value of the battery does not exceed a second threshold value.

9. The apparatus of claim 1, wherein the processor releases the limitation of the cell voltage based on that a value obtained by subtracting an actual output value from a target output value of the fuel cell stack exceeds a value obtained by subtracting an output distribution value and a margin of the battery from the maximum output value of the battery.

10. The apparatus of claim 1, wherein the processor:
determines the lower limit voltage of the cell voltage within the fuel cell stack based on the SOC value and the maximum output value of the battery and the output voltage of the fuel cell stack, and
re-limits the cell voltage to the lower limit voltage based on that the limitation of the cell voltage is released.

11. A method for controlling a cell voltage of a fuel cell stack, the method comprising:
obtaining, by a processor, a state of charge (SOC) value and a maximum output value of a battery disposed in a fuel cell vehicle;
obtaining, by the processor, an output voltage of a fuel cell stack disposed in the fuel cell vehicle;
determining, by the processor, a lower limit voltage of a cell voltage within the fuel cell stack based on the SOC value and the maximum output value of the battery and the output voltage of the fuel cell stack; and
limiting, by the processor, the cell voltage to the lower limit voltage.

12. The method of claim 11, wherein the determining of the lower limit voltage includes determining the lower limit voltage of the cell voltage based on that the SOC value of the battery exceeds a first reference SOC value.

13. The method of claim 11, wherein the determining of the lower limit voltage includes determining the lower limit voltage of the cell voltage based on that the maximum output value of the battery exceeds a first threshold value.

14. The method of claim 11, wherein the determining of the lower limit voltage includes determining the lower limit voltage of the cell voltage based on that the output voltage of the fuel cell stack exceeds a threshold voltage.

15. The method of claim 11, further comprising:
determining, by the processor, a lower limit voltage of the fuel cell stack corresponding to the lower limit voltage of the cell voltage; and
limiting, by the processor, a target output of the fuel cell stack based on that the output voltage of the fuel cell stack reaches the lower limit voltage of the fuel cell stack.

16. The method of claim 11, wherein the obtaining of the output voltage of the fuel cell stack includes obtaining a bidirectional high voltage converter (BHDC) voltage command as the output voltage of the fuel cell stack.

17. The method of claim 11, further comprising:
obtaining, by the processor, a target output value and an actual output value of the fuel cell stack;
releasing, by the processor, the limitation of the cell voltage based on the SOC value and the maximum output value of the battery, and the target output value and the actual output value of the fuel cell stack;
determining the lower limit voltage of the cell voltage within the fuel cell stack based on the SOC value and the maximum output value of the battery and the output voltage of the fuel cell stack; and
re-limiting the cell voltage to the lower limit voltage.

18. The method of claim 17, wherein the releasing of the limitation of the cell voltage includes:
releasing the limitation of the cell voltage based on that the SOC value of the battery does not exceed a second reference SOC value.

19. The method of claim 17, wherein the releasing of the limitation of the cell voltage includes releasing the limitation of the cell voltage based on that the maximum output value of the battery does not exceed a second threshold value.

20. The method of claim 17, wherein the releasing of the limitation of the cell voltage includes releasing the limitation of the cell voltage based on that a value obtained by subtracting an actual output value from a target output value of the fuel cell stack exceeds a value obtained by subtracting an output distribution value and a margin of the battery from the maximum output value of the battery.
